(19) United States
(12) Patent Application Publication
(10) Pub. No.: US 2007/0182766 A1
(43) Pub. Date: Aug. 9, 2007

(54) Apparatus to fabricate color filter and method thereof

(75) Inventors: Seog-soon Baek, Suwon-si (KR); Seong-jin Kim, Seongnam-si (KR); Seung-joo Shin, Seoul (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/453,004

(22) Filed: Jun. 15, 2006

(30) Foreign Application Priority Data
Feb. 9, 2006 (KR) 2006-12604

(51) Int. Cl. B05D 5/00; B05D 3/10; B41J 2/01

(52) U.S. Cl. 347/1; 427/256; 427/336

(57) ABSTRACT

An apparatus to fabricate a color filter includes an inkjet head movably installed over a substrate on which a plurality of pixels are formed to discharge ink of predetermined colors into the pixels, and a porous member movably installed over the pixels filled with the ink discharged from the inkjet head to form a solvent ambient around the ink filled within the pixels due to evaporation of a solvent filled in the porous member to reduce a drying speed of the ink.

### CROSS-REFERENCE TO RELATED APPLICATIONS

This application claims priority under 35 U.S.C. §119(a) from Korean Patent Application No. 10-2006-0012604, filed on Feb. 9, 2006, in the Korean Intellectual Property Office, the disclosure of which is incorporated herein in its entirety by reference.

### BACKGROUND OF THE INVENTION

1. Field of the Invention

The present general inventive concept relates to an apparatus to fabricate a color filter, and more particularly, an apparatus to fabricate a color filter in which ink layers having uniform thicknesses are formed within pixels of the color filter and a method thereof.

2. Description of the Related Art

Until recently, cathode ray tube (CRT) monitors have been usually used to display information from TVs and computers. However, flat panel displays, such as liquid crystal displays (LCDs), plasma display panels (PDPs), electro-luminescence (EL) displays, light emitting diodes (LEDs), and field emission displays (FEDs), are now being used with an increase in sizes of screens. LCDs among these flat panel displays are widely used as desk-top computer monitors, lap-top computer monitors, etc., because the LCDs have low power consumption.

The LCDs include a color filter that forms images of desired colors by transmitting white light modulated by a liquid crystal layer. The color filter includes an arrangement of a plurality of red (R), green (G), and blue (B) pixels formed on a transparent substrate. The color filter has been fabricated using conventional methods including a dyeing method, a pigment dispersion method, a printing method, an electrodeposition method, etc. However, these conventional methods include a repetition of predetermined processes for pixels of each color, thus degrading process efficiency and increasing fabrication costs.

Accordingly, a conventional method of fabricating a color filter using an inkjet printing technique has been recently proposed, which is performed more simply and cost-effectively as compared to other conventional methods. This method is illustrated in FIG. 1, in which a color filter is fabricated using an inkjet head 30 as an apparatus to manufacture the color filter using the inkjet printing technique. Referring to FIG. 1, ink drops 40 of predetermined colors, such as red (R), green (G), and blue (B), are discharged into pixels 22 defined by walls of a matrix 20 on a substrate 10 through nozzles of the inkjet head 30, whereby the pixels 22 are filled with liquid ink 50. Then, the liquid ink 50 is dried to thereby fabricate the color filter. However, while the liquid ink 50 is drying, a variety of mass flows occur within the pixels 22 according to a drying speed of the liquid ink 50. Accordingly, thicknesses of ink layers formed within the pixels 22 defined by the walls of the matrix 20 after the liquid ink 50 has dried may be non-uniform.

Additionally, partial pressures of solvent vapor evaporated from the liquid ink 50 during the drying of the liquid ink 50 are smaller at pixels 22 located at edge portions of the color filter than at pixels 22 located on inner side portions of the color filter. Hence, the liquid ink 50 within the pixels 22 located at the edge portions of the color filter dry faster than the liquid ink 50 within the pixels 22 located on the inner side portion of the color filter. Thus, ink layers formed within the pixels 22 located at the edge portions of the color filter may have more non-uniform thicknesses than ink layers formed within the pixels 22 located on the inner side portions of the color filter. Ink layers having non-uniform thicknesses within the pixels 22 may cause light to leak from the pixels 22. Furthermore, since the pixels 22 having ink layers with a large thickness variation are concentrated on a specific location of the color filter, that is, on the edge portions of the color filter, a quality of a panel is negatively affected, such as by a generation of a blurry image.

### SUMMARY OF THE INVENTION

The present general inventive concept provides an apparatus to fabricate a color filter in which ink layers having uniform thicknesses are formed within pixels of the color filter.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an apparatus to fabricate a color filter, the apparatus including an inkjet head movably installed over a substrate to discharge ink of predetermined colors into pixels formed on the substrate, and a porous member movably installed over the pixels to form a solvent ambient around the ink discharged into the pixels due to an evaporation of a solvent in the porous member to reduce a drying speed of the ink discharged into the pixels.

The porous member may be attached to the inkjet head. The porous member may be attached to at least one lateral side of the inkjet head.

The porous member and the inkjet head may be spaced apart from each other by a predetermined distance. The porous member and the inkjet head may be moveable at different speeds.

A time interval during which the porous member moves across the substrate is equal to a time interval during which the inkjet head moves across the substrate.

The porous member may include a ceramic or a high polymer. Pores formed in the porous member may be connected to one another. The pores may have a size of no more than 1 μm. The pores may be smaller than a thickness of the porous member.

The apparatus may further include a solvent supply unit connected to the porous member to supply the solvent to the porous member. The solvent supply unit may supply an amount of the solvent which is substantially the same as an amount of the solvent evaporated from the porous member.

The porous member may be attached to at least two lateral sides of the inkjet head. At least one of the inkjet printhead and the porous member may be attached to the other of the inkjet printhead and the porous member. The solvent of the porous member may be different from a solvent of the ink. A size of the porous member and a size of the inkjet head may be substantially the same.

The foregoing and/or other aspects and utilities of the present general inventive concept may also be achieved by providing a system to fabricate a color filter, including a transparent substrate having a plurality of pixels, an inkjet printhead to discharge ink into the pixels, and a porous member having a solvent to form a solvent ambient over the ink discharged into the pixels to generate ink layers having uniform thicknesses in the corresponding pixels.

The system may further include a control unit to control the porous member to move across the substrate during a first time interval and to control the inkjet printhead to move across the substrate during a second time interval. The first and second time intervals may be identical. Durations of the first and second time intervals may be identical. The system may further include a driving unit to drive a movement of the inkjet print head at a first speed and to drive a movement of the porous member at a second speed. The first and second speeds may be identical.

The foregoing and/or other aspects and utilities of the present general inventive concept may also be achieved by providing a system to fabricate a color filter, including an inkjet printhead to discharge ink, and a porous member to supply a solvent toward the discharged ink. The system may further include a substrate having a plurality of pixels, the ink may be filled in the plurality of pixels, and the solvent may be supplied over the ink filled in the plurality of pixels. The plurality of pixels may include a plurality of first sub-pixels and a plurality of second sub-pixels, and the porous member may supply a first amount of the solvent to the first sub-pixels and a second amount of the solvent to the second sub-pixels. The porous member may maintain a uniform solvent ambient around the pixels to control a drying speed of the ink in the pixels.

The foregoing and/or other aspects and utilities of the present general inventive concept may also be achieved by providing a color filter having color pixels, including a substrate having an edge portion and an inner portion, a plurality of first pixels formed in the edge portions of the substrate, a plurality of second pixels formed in the inner portion of the substrate, ink filled in the corresponding first and second pixels to form first and second color pixels using a solvent applied around the ink filled in the corresponding first and second pixels such that the first color pixels and the second color pixels may have substantially the same height.

The foregoing and/or other aspects and utilities of the present general inventive concept may also be achieved by providing a method of fabricating a color filter, including discharging ink into a plurality of pixels of a transparent substrate using an inkjet printhead, and supplying a solvent toward the ink filled in the pixels.

The foregoing and/or other aspects and utilities of the present general inventive concept may also be achieved by providing a method of making a color filter having color pixels, including forming a plurality of first pixels in edge portions of a substrate, forming a plurality of second pixels in an inner portion of the substrate, filling ink in the corresponding first and second pixels to form first and second color pixels, and applying a solvent around the ink filled in the corresponding first and second pixels.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view illustrating a conventional method of fabricating a color filter in a conventional apparatus;

FIG. 2 is a perspective view illustrating an apparatus to fabricate a color filter according to an embodiment of the present general inventive concept;

FIG. 3 is a view illustrating a method of fabricating a color filter using the apparatus of FIG. 2;

FIG. 4 is a view illustrating a color filter fabricating apparatus according to another embodiment of the present general inventive concept and a method of fabricating a color filter using the color filter fabricating apparatus;

FIG. 5 is a view illustrating a color filter fabricating apparatus according to another embodiment of the present general inventive concept; and

FIG. 6 is a view illustrating heights of color pixels in an edge portion and an inner portion of a color filter according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. In the drawings, the thicknesses of elements are exaggerated for clarity. The embodiments are described below in order to explain the present general inventive concept by referring to the figures.

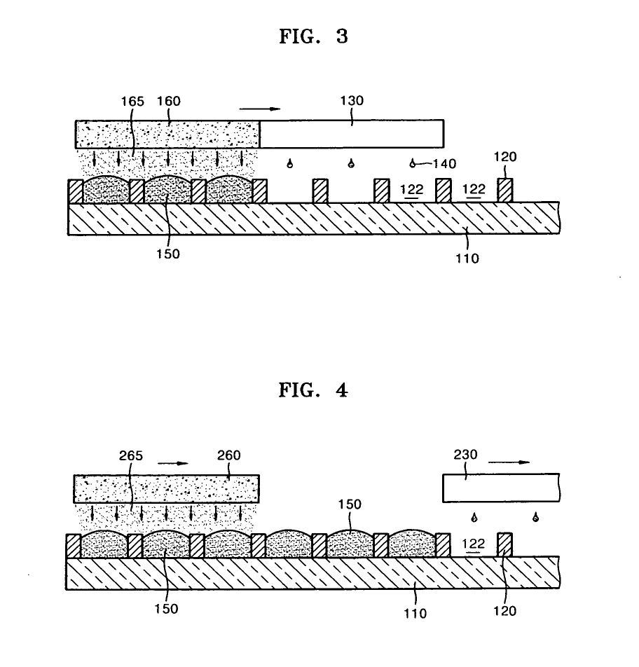

FIG. 2 is a perspective view illustrating an apparatus to fabricate a color filter according to an embodiment of the present general inventive concept. FIG. 3 illustrates a method of fabricating the color filter using the apparatus of FIG. 2. Referring to FIGS. 2 and 3, the apparatus to fabricate the color filter includes an inkjet head 130 and a porous member 160 attached to the inkjet head 130. The inkjet head 130 is movably placed over a substrate 110 a predetermined distance away from the substrate 110. The inkjet head 130 includes a plurality of nozzles (not illustrated) through which ink drops 140 are discharged. The substrate 110 is transparent and may be, for example, a glass substrate or a plastic substrate. A black matrix 120 defining a plurality of pixels 122 is formed on the substrate 110. The inkjet head 130 discharges ink drops 140 of predetermined colors, such as red (R), green (G), and blue (B), into corresponding ones of the pixels 122, so that the pixels 122 are filled with ink 150 of the predetermined colors to form color pixels, for example red (R) pixels, green (G) pixels, and blue (B) pixels.

The porous member 160 is located over the pixels 122 filled with the ink 150 of the predetermined colors by the inkjet head 130. The porous member 160 has a plurality of pores 161 which are filled with a solvent. The solvent filled in the pores 161 of the porous member 160 evaporates to form a solvent ambient 165 around the ink 150 filled within the pixels 122. The solvent ambient 165 reduces a drying speed of the ink 150 since the solvent ambient 165 surrounds a surface of liquid ink of the pixels or increases a density above the liquid ink.

A time interval during which the porous member 160 moves across the substrate 110 may be set to be equal to a time interval during which the inkjet head 130 moves across the substrate 110. Alternatively, the time interval during which the porous member 160 moves across the substrate 110 may be set to be different from the time interval during which the inkjet head 130 moves across the substrate 110. For example, the porous member 160 may move across the substrate 110 during a first time interval and the inkjet head 130 may move across the substrate 110 during a second time interval, and the first and second time intervals may be identical or different. Furthermore, durations of the first and second time intervals may be identical or different. The porous member 160 may supply a first amount of solvent to edge portions of the pixels 122 of the color filter and a second amount of solvent to an inner portion of the pixels 122 of the color filter to control the drying speed of the entire pixels 122 or to maintain the same drying speed of the pixels 122 in the edge and inner portions of the color filter.

The porous member 160 may be formed of, for example, a ceramic or a high polymer (i.e., a polymer composed of a large number of monomers). The pores 161 of the porous member 160 may be about 1 μm or less in size. The pores 161 may be smaller than a thickness of the porous member 160. The pores 161 may be connected to one another to keep an effective amount of the solvent (e.g., an amount necessary to reduce the speed at which the ink 150 is dried) filled within the porous member 160. The solvent filled within the porous member 160 may be composed of a material identical with the material of a solvent included in the ink 150. Alternatively, the solvent of the porous member 160 may be composed of a material different from the solvent included in the ink 150. For example, the solvent of the porous member 160 may be composed of at least one of di(propylene glycol) methyl ether acetate (DPMA), propylene glycol monomethyl ether acetate (PGMEA), ethyle acetate, and acetone.

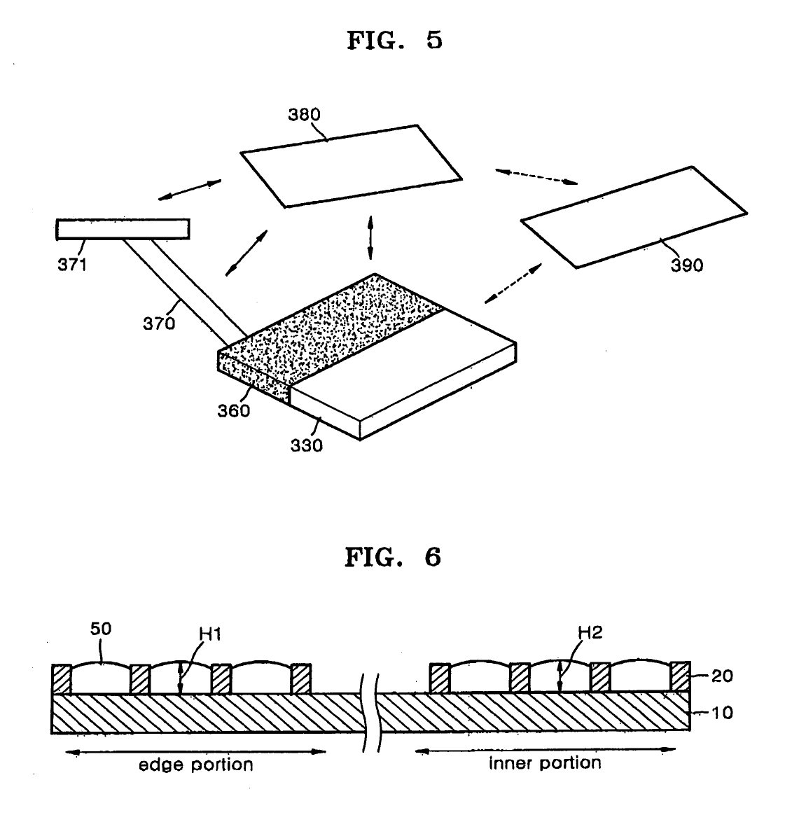

The porous member 160 may be attached to one lateral side of the inkjet head 130, as illustrated in FIGS. 2 and 3. Alternatively, the porous member 160 may be attached to at least two lateral sides of the inkjet head 130. The phrase “lateral side” indicates a side that is not a top or a bottom side of the inkjet head 130, such as a left side, a right side, a front side, and a back side. When the porous member 160 is attached to at least one lateral side of the inkjet head 130, as illustrated in FIG. 2, the porous member 160 moves at the same speed as the inkjet head 130. A solvent supply unit, such as a solvent supply pipe 370 illustrated in FIG. 5, to supply solvent to the porous member 160 may be connected to the porous member 160. The solvent supply unit may supply an amount of solvent to the porous member 160 corresponding to an amount of solvent that evaporates from the ink 50 upon drying thereof The solvent supply unit, such as the solvent supply pipe 370, may be connected to a solvent reservoir, such as the solvent reservoir 371 illustrated in FIG. 5. It is also possible that the solvent supply unit may control the reservoir 371 or the supply pipe 370 or the porous member 360 to supply a first amount of solvent to the pixels 122 disposed in the edge portion of the color filter and a second amount of solvent to the pixels 122 disposed in the inner portion of the color filter so that the second amount is smaller than the first amount.

As illustrated in FIG. 2, the porous member 160 may have a size that is substantially the same as a size of the inkjet head 130. Alternatively, the size of the porous member 160 may be larger than or smaller than the size of the inkjet head 130.

In the color filter fabricating apparatus according to this embodiment, the ink drops 140 are discharged from the inkjet head 130 into the pixels 122 formed on the substrate 110 so that the pixels 122 are filled with the ink 150 of the predetermined colors. Then, the inkjet head 130 and the porous member 160 are moved so that the porous member 160 is positioned over the pixels 122 filled with the ink 150. In this state, the solvent in the porous member 160 evaporates, so that a solvent ambient 165 is formed around the ink 150. Specifically, the evaporated solvent forms a solvent environment in a space between the porous member 160 and the pixels 22 filled with the ink 150, as illustrated in FIG. 2. When the solvent ambient 165 is present around the ink 150, the drying speed of the ink 150 filled in the pixels 122 is uniformly decreased, and ink layers having uniform thicknesses can be formed within the pixels 122 after the drying of the ink 150.

In the present embodiment, the porous member 160 is attached to the inkjet head 130 and thus moves at the same speed as the inkjet head 130. However, in this case, when the inkjet head 130 and the porous member 160 move quickly, the solvent ambient 165 around the ink 150 filled in the pixels 122 may not be effectively maintained so as to uniformly decrease the drying speed of the ink 150 in the pixels 122 and/or to cause the resulting ink layers to have a uniform thickness. To address this issue, there is provided a color filter fabricating apparatus according to another embodiment of the present general inventive concept, which is illustrated in FIG. 4. Only the differences between the two embodiments will now be described.

Referring to FIG. 4, the color filter fabricating apparatus according to another embodiment of the present general inventive concept includes an inkjet head 230 and a porous member 260. The inkjet head 230 and the porous member 260 are movably installed over the substrate 110. In contrast with the previous embodiment, the porous member 260 is spaced apart from one lateral side of the inkjet head 230 by a predetermined distance, as illustrated in FIG. 4.

In this embodiment, the porous member 260 may move at a different speed from the inkjet head 230, for example, at a slower speed than the inkjet head 130. Alternatively, the porous member 260 may move at the same speed as or a faster speed than the inkjet head 230. The moving speed of the porous member 260 may be optimized so as to form an effective solvent ambient 265 around ink 150 filled within pixels 122, i.e., so as to uniformly decrease the drying speed of the ink 150 in the pixels 122 and/or to cause the resulting ink layers to have a uniform thickness.

The pores 161 of the porous member 160 are filled with a solvent. A solvent supply unit, such as the solvent supply pipe 370 illustrated in FIG. 5, to supply solvent to the porous member 260 may be connected to the porous member 260. The solvent supply unit may supply an amount of solvent to the porous member 260 corresponding to an amount of solvent that evaporates from the ink 150 upon drying thereof. The solvent supply unit, such as the solvent supply pipe, may be connected to a solvent reservoir, such as the solvent reservoir 371 illustrated in FIG. 5.

In the color filter fabricating apparatus of this embodiment, ink drops are discharged from the inkjet head 230 into the pixels 122 formed on the substrate 110 so that the pixels 122 are filled with the ink 150 of the predetermined colors. Then, the porous member 260 is moved and positioned over the pixels 122 filled with the ink 150. In this state, the solvent in the porous member 260 evaporates, so that a solvent ambient 265 is formed around the ink 150 filled within the pixels 122. When the solvent ambient 265 is present, a drying speed of the ink 150 filled in the pixels 122 is uniformly decreased, and ink layers having uniform thicknesses are formed within the pixels 122 after the drying of the ink 150.

FIG. 5 is a view illustrating a color filter fabricating apparatus according to another embodiment of the present general inventive concept. As illustrated in FIG. 5, the apparatus may include a control unit 380 to control a porous member 360 to move across the substrate 110 during a first time interval and to control an inkjet head 330 to move across the substrate 110 during a second time interval, and the first and second time intervals may be identical or different. Furthermore, durations of the first and second time intervals may be different or identical. In addition, the control unit 380 may control the inkjet head 330 to move at a first speed and control the porous member 360 to move at a second speed, and the first and second speeds may be identical or different. The apparatus may also include a driving unit 390 to drive the movement of the inkjet head 330 at the first speed and to drive the movement of the porous member 360 at the second speed, and the first and second speeds may be identical or different.

Although in FIG. 5 the porous member 360 and the inkjet head 330 are attached to each another, the porous member 360 and the inkjet head 330 may instead be spaced apart from each other by a predetermined distance. Furthermore, the control unit 380 may separately control one or both of the porous member 360 and the inkjet head 330, or may control the porous member 360 and the inkjet head 330 together as a single unit. Moreover, the drive unit 390 may separately drive the movement of one or both of the porous member 360 and the inkjet head 330, or may drive the movement of the porous member 360 and the inkjet head 330 together as a single unit.

FIG. 6 is a view illustrating heights of color pixels in an edge portion and an inner portion of a color filter according to an embodiment of the present general inventive concept. As illustrated in FIG. 6, a height H1 of the color pixels 122 in the edge portion of the color filter is substantially the same as a height H2 of the color pixels 122in the inner portion of the color filter

As described above, a color filter fabricating apparatus according to the present general inventive concept can uniformly reduce a drying speed of ink filled within pixels on a substrate by using a solvent ambient formed around the ink. Thus, ink layers having uniform thicknesses are formed within the pixels after the drying of the ink.

Although a color filter fabricating apparatus which is usually used in LCDs has been illustrated, this apparatus may be equally applied to a formation of an organic light emitting layer using an inkjet printing technique in a manufacture of an organic light emitting diode (OLED) or a formation of an organic semiconductor using an inkjet printing technique in a manufacture of an organic thin film transistor (OTFT).

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An apparatus to fabricate a color filter, the apparatus comprising:
an inkjet head movably installed over a substrate to discharge ink of predetermined colors into pixels formed on the substrate; and
a porous member movably installed over the pixels to form a solvent ambient around the ink discharged into the pixels due to an evaporation of a solvent in the porous member to reduce a drying speed of the ink discharged into the pixels.

2. The apparatus of claim 1, wherein the porous member is attached to the inkjet head.

3. The apparatus of claim 2, wherein the porous member is attached to at least one lateral side of the inkjet head.

4. The apparatus of claim 1, wherein the porous member and the inkjet head are spaced apart from each other by a predetermined distance.

5. The apparatus of claim 4, wherein the porous member and the inkjet head are moveable at different speeds.

6. The apparatus of claim 1, wherein a time interval during which the porous member moves across the substrate is equal to a time interval during which the inkjet head moves across the substrate.

7. The apparatus of claim 1, wherein the porous member comprises a ceramic or a high polymer.

8. The apparatus of claim 1, wherein pores formed in the porous member are connected to one another.

9. The apparatus of claim 8, wherein the pores have a size of no more than about 1 μm.

10. The apparatus of claim 8, wherein the pores are smaller than a thickness of the porous member.

11. The apparatus of claim 1, further comprising:
a solvent supply unit connected to the porous member to supply the solvent to the porous member.

12. The apparatus of claim 11, wherein the solvent supply unit supplies an amount of the solvent which is substantially the same as an amount of the solvent evaporated from the porous member.

13. The apparatus of claim 2, wherein the porous member is attached to at least two lateral sides of the inkjet head.

14. The apparatus of claim 1, wherein at least one of the inkjet printhead and the porous member is attached to the other of the inkjet printhead and the porous member.

15. The apparatus of claim 1, wherein the solvent of the porous member is different from a solvent of the ink.

16. The apparatus of claim 1, wherein a size of the porous member and a size of the inkjet head are substantially the same.

17. A system to fabricate a color filter, comprising:
a transparent substrate having a plurality of pixels;
an inkjet printhead to discharge ink into the pixels; and
a porous member having a solvent to form a solvent ambient over the ink discharged into the pixels to generate ink layers having uniform thicknesses in the corresponding pixels.

18. The system of claim 17, further comprising:
a control unit to control the porous member to move across the substrate during a first time interval and to control the inkjet printhead to move across the substrate during a second time interval.

19. The system of claim 18, wherein the first and second time intervals are identical.

20. The system of claim 18, wherein durations of the first and second time intervals are identical.

21. The system of claim 17, further comprising:
a driving unit to drive a movement of the inkjet print head at a first speed and to drive a movement of the porous member at a second speed.

22. The system of claim 18, wherein the first and second speeds are identical.

23. A system to fabricate a color filter, comprising:
an inkjet printhead to discharge ink; and
a porous member to supply a solvent toward the discharged ink.

24. The system of claim 23, further comprising:
a substrate having a plurality of pixels,
wherein the ink is filled in the plurality of pixels, and the solvent is supplied over the ink filled in the plurality of pixels.

25. The system of claim 24, wherein the plurality of pixels comprises a plurality of first sub-pixels and a plurality of second sub-pixels, and the porous member supplies a first amount of the solvent to the first sub-pixels and a second amount of the solvent to the second sub-pixels.

26. The system of claim 24, wherein the porous member maintains a uniform solvent ambient around the pixels to control a drying speed of the ink in the pixels.

27. A color filter having color pixels, comprising:
a substrate having an edge portion and an inner portion;
a plurality of first pixels formed in the edge portions of the substrate;
a plurality of second pixels formed in the inner portion of the substrate;
ink filled in the corresponding first and second pixels to form first and second color pixels using a solvent applied around the ink filled in the corresponding first and second pixels, such that the first color pixels and the second color pixels have substantially the same height.

28. A method of fabricating a color filter, comprising:
discharging ink into a plurality of pixels of a transparent substrate using an inkjet printhead; and
supplying a solvent toward the ink filled in the pixels.

29. A method of making a color filter having color pixels, comprising:
forming a plurality of first pixels in edge portions of a substrate;
forming a plurality of second pixels in an inner portion of the substrate;
filling ink in the corresponding first and second pixels to form first and second color pixels; and
applying a solvent around the ink filled in the corresponding first and second pixels.
